(19) United States
(12) Patent Application Publication
(10) Pub. No.: US 2011/0100285 A1
(43) Pub. Date: May 5, 2011

(54) WATERCRAFT WITH REMOVABLE HULLS

(75) Inventor: Montgomery Scott GISBORNE, Brechin (CA)

(73) Assignees: Ray Hirani, Kitchener (CA); Montgomery Scott Gisborne, Brechin (CA)

(21) Appl. No.: 12/637,261

(22) Filed: Dec. 14, 2009

Related U.S. Application Data
(63) Continuation-in-part of application No. 12/608,148, filed on Oct. 29, 2009.

(51) Int. Cl. B63B 3/00; B23P 19/00

(52) U.S. Cl. 114/355; 29/426.1

(57) ABSTRACT

A method of preparing a boat for transportation or storage. The boat preferably has two hulls or pontoons. The two hulls can be removed and placed on the deck of the boat for storage. In addition, the roof of the boat can be lowered such that the boat occupies a minimal amount of space.

### CROSS-REFERENCE TO RELATED APPLICATION

This application is a continuation-in-part of U.S. application Ser. No. 12/608,148 filed Oct. 29, 2009 entitled, Retractable Boat Roof, the disclosure of which is incorporated by reference herein.

### TECHNICAL FIELD

The present invention relates to watercraft. More particularly, the present invention relates to improvements in the construction of watercraft which allow for the partial disassembly and compact storage of the watercraft. The present invention also relates to improvements in the structure of watercraft which allow for the deployment and retraction of the roof and allow for easy storage and road transportation of the watercraft.

### BACKGROUND OF THE INVENTION

Watercraft which have structures suitable for reducing the amount of space they occupy for transportation or storage are known. For example, U.S. Pat. Nos. 2,339,782 and 6,325,013 disclose boats with sections which may be detached from one another. U.S. Pat. No. 6,029,598 discloses a boat with removable pontoons for storage on the roof of the cabin. However, the boat disclosed in this patent does is not significantly reduced in size when the pontoons are removed and stored on the roof of the boat.

It is desirable to have a watercraft with removable hulls which can be easily disassembled and reassembled. It is also desirable to have a watercraft which fills a minimal amount of space for transportation, but which can be quickly and easily reassembled once the watercraft reaches its destination.

In addition, it is desirable to have a boat with a retractable roof which further reduces the space the boat occupies for transportation and storage. Such boats are known. For example, U.S. Pat. No. 5,016,558, discloses a boat with a retractable roof. However, the retractable roof disclosed in this patent has several drawbacks. The roof is manually operated, which, for larger roofs could require considerable strength to operate. It is possible that the person operating the roof could be injured while moving the roof by trying to control its movement. Also, once the roof has been unlatched for movement from the deployed position to the retracted position, there is nothing preventing the rapid movement of the roof between the two positions. It is desirable to have a retractable roof which can be automatically moved between the deployed and the retracted positions. It is also desirable to have a retractable roof which can be moved automatically in a controlled motion, while remaining horizontal, between the deployed and retracted positions.

### BRIEF SUMMARY OF THE INVENTION

The present invention includes a method of preparing a boat for transportation or storage. The boat preferably has two hulls or pontoons. However, the present invention is not limited to a two hull boat. The boat also includes a deck and has an outside perimeter. The method includes detaching the hulls from the boat and placing the hulls on the deck, in spaces on the deck sized to receive the hulls. The hulls are placed such that the hulls do not extend substantially beyond the outside perimeter of the boat. In one embodiment, the hulls are attached to the boat by bolts, although many other attachment methods are possible, as would be appreciated by one of ordinary skill in the art. Preferably, the bolts are inserted through access panels in the deck of the boat into the hulls. As described in more detail below, to further reduce the amount of space occupied by the boat, the roof of the boat may be moved from a position above the deck to a position substantially closer to the deck.

The combination of placing the hulls on the deck and lowering the roof results in a compact configuration of the boat for shipping or transportation. With the hulls on the deck and the roof in the retracted position, four boats of adequate size can fit into a single high cube shipping container, resulting in the efficient transportation of the boats from a factory to the point of sale.

In another embodiment, a boat is constructed such that a hull is removably attached to the boat. The deck includes an area sized to receive the hull. The deck has a perimeter sized such that when the area receives the hull, the hull does not extend substantially outside of the perimeter. In another embodiment, a second hull is removably attached to the boat and the deck includes a second area sized to receive the second hull such that the second hull does not extend substantially outside of the perimeter.

The hulls can be connected to the boat in any number of ways. In one embodiment, the boat includes an upper hull section. The deck includes openings therein and the hull is attached to the upper hull section with bolts inserted through the openings in the deck, through the upper hull section and into the hull. In another embodiment, the boat has a peripheral flange around the upper hull section and the hull includes a flange. The hull is attached to the boat by bolts extending through the flange in the hull and through the peripheral flange in the boat.

The present invention includes, in some embodiments, a retractable roof assembly for the boat. As used herein roof refers to either a roof attached to a roof support structure, a roof with an integrated support structure, or a roof with sufficient structural integrity such that no support structure is needed. The retractable roof assembly preferably includes four struts pivotally attached to the boat. The struts are preferably attached to pivot anchors near the boat's deck which are supported by an internal framework. The roof is operatively attached to at least two of the four struts.

The roof includes at least one cam surface. At least one of the struts preferably includes a roller attached to it which is adapted for movement along the cam surface. A motor or plurality of motors moves the roof such that the roof moves from a first position in which the roof is above the boat to a second position in which the roof is substantially closer to the boat. Preferably, when moving from the first (deployed) position to the second (retracted) position, the roof remains substantially horizontal. The motor can move the roof with a screw drive, a belt drive, a chain drive or other driving mechanism. Preferably, the assembly includes a second motor. The motors can be attached to guide members on the roof. Preferably, one or both of the guide members have cam surfaces. As will be described in more detail below, the cam surfaces allow for movement of the roof while maintaining the roof in a generally horizontal orientation. Alternatively, a curved slot can replace the cam surface to achieve the same result.

In some embodiments, the guide member includes a slot and a support bar is attached to the struts. The support member passes through the guide member such that the support bar moves within the slot as the roof moves between the first and second positions. It is also possible to include a second guide member. A second motor can be attached to the second guide member. The second guide member can also include a slot and the support bar can pass through the slot in the second guide member such that the support bar moves within the slot in the second guide member as the roof moves between the first and second positions.

The roof is preferably sized such that it does not extend along the entire length of the boat deck. In some embodiments, the roof covers less than eighty percent of the boat deck. The roof can leave either a portion of the bow or a portion of the stern uncovered.

### BRIEF DESCRIPTION OF THE SEVERAL VIEWS OF THE DRAWINGS

FIG. 1 is a side elevation view of one embodiment of the present invention;

FIG. 2. is a side elevation view of the embodiment of FIG. 1 showing the roof partially retracted;

FIG. 3 is a side elevation view of the embodiment of FIG. 1 showing the roof fully retracted;

FIG. 4a is a perspective view of a portion of the embodiment of FIG. 1 showing the details of one motor used to move the roof;

FIG. 4b is a perspective view of another portion of the embodiment of FIG. 1 showing the details of another motor used to move the roof;

FIG. 4c is a perspective view of a portion of another embodiment of the present invention;

FIG. 4d is a perspective view of a portion of another embodiment of the present invention;

FIG. 5 is a perspective view of the embodiment of FIG. 1;

FIG. 6 is a perspective view of a portion of the embodiment of FIG. 1;

FIG. 7 is a perspective view of another portion of the embodiment of FIG. 1;

FIG. 8 is a is a perspective view of another embodiment of the present invention showing the roof in a retracted position and the hull sections on the boat deck;

FIG. 9 is a perspective view of the embodiment of FIG. 8 with the roof removed for illustration purposes;

FIG. 10 is a side elevation view of a shipping container with four boats made in accordance with one embodiment of the present invention inside the shipping container;

FIG. 11 is a end elevation view of the shipping container of FIG. 10;

FIG. 12 is a perspective view of a portion of one embodiment of the boat of the present invention;

FIG. 13 is an exploded perspective view of the embodiment of the invention of FIG. 12;

FIG. 14 is a cross-sectional view illustrating an attachment method used in connection with the embodiment of FIG. 13;

FIG. 15 is a perspective view of a portion of another embodiment of the boat of the present invention; and

FIG. 16 is a cross-sectional view illustrating an attachment method used in connection with the embodiment of FIG. 15.

### DETAILED DESCRIPTION OF THE PREFERRED EMBODIMENTS OF THE INVENTION

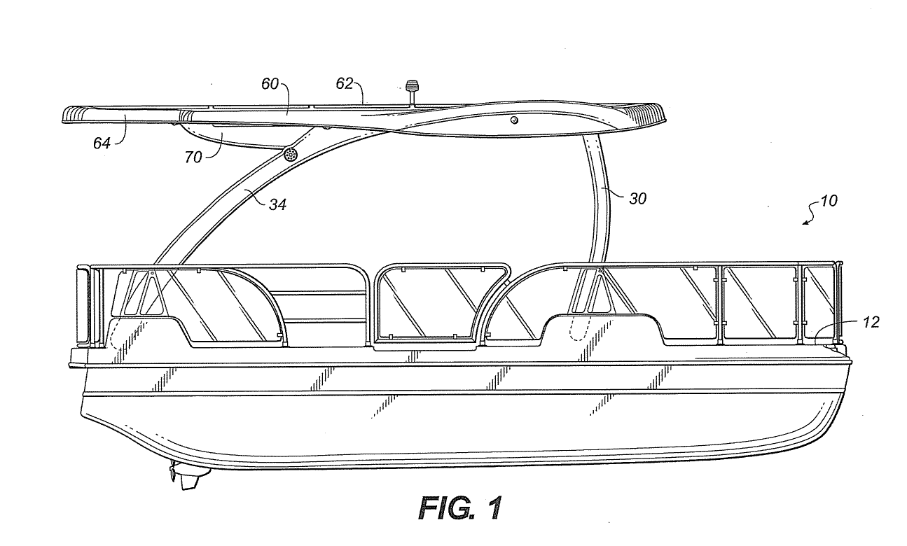

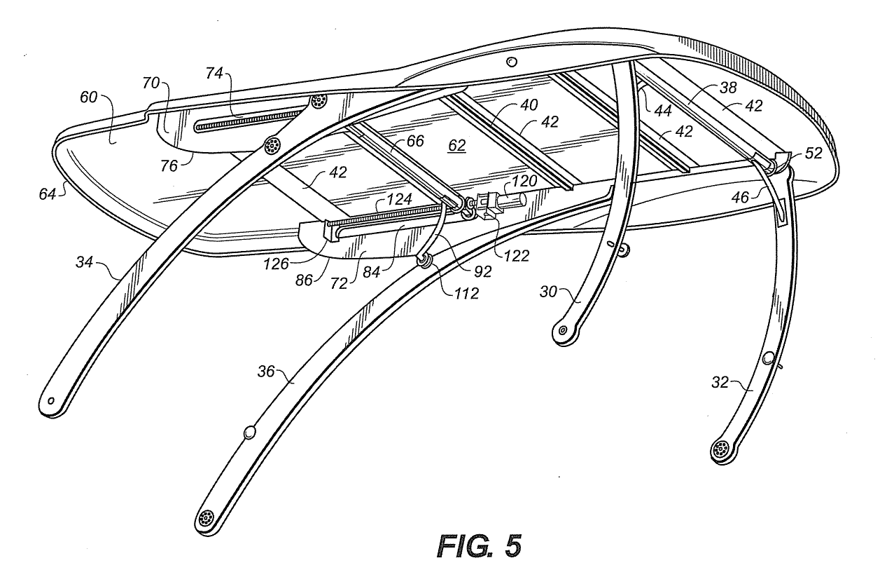

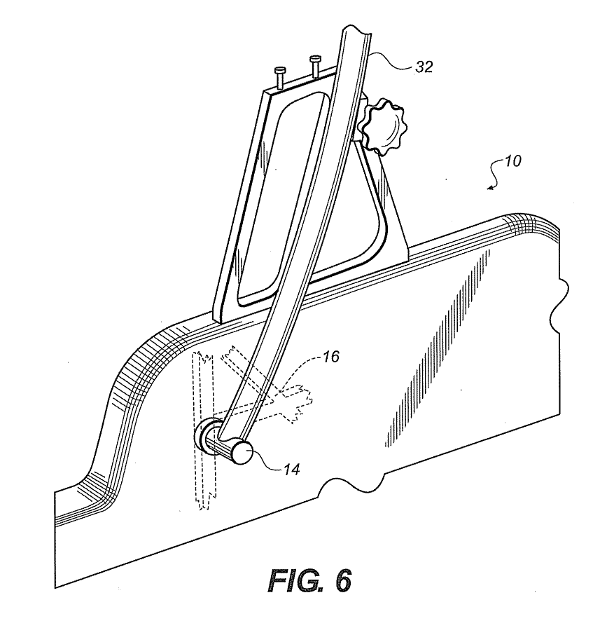

FIGS. 1-16 illustrate the present invention. As illustrated in FIGS. 1-7, the retractable roof is shown in connection with a pontoon style boat. It will be understood by those of ordinary skill in the art that the retractable roof of the present invention can be used in connection with many other types of boats. Preferably, the boat 10 includes a deck 12 with four lower pivot anchors 14 (FIGS. 6 and 7, only two front shown) attached to the deck 12. Two front struts 30 and 32 are pivotally connected to pivot anchors 14 with pivot connections made in a conventional manner. The pivot anchors 14 are supported by internal framework 16 to support the weight of the struts 30 and 32. As shown in FIG. 5, the struts 30 and 32 are connected to one another through rod 38. Two rear struts 34 and 36 are pivotally connected with to pivot anchors 14 in a conventional manner. The struts 30, 32, 34 and 36 are preferably made from any suitable material such as fiber-reinforced plastic, thermoformed plastic, aluminum, or other suitable material. For structural rigidity, the struts 30, 32, 34 and 36 can have a metal tube core (not shown) surrounded by foam (not shown) with a fiber-reinforced plastic shell.

Preferably, a roof support structure 40 is provided with support members 42 (FIG. 5). The roof 60 is mounted on the roof support members 42; those of skill in the art will recognize that other structures are possible to support the roof 60. It is also possible to integrate the roof and support structure into a single structure. The roof 60 is preferably made from fiber-reinforced plastic, thermoformed plastic, aluminum or other suitable material. Preferably, the roof 60 and other structures of the boat 10 are made from material which will not deteriorate in the harsh conditions found on freshwater and saltwater marine environments.

In one embodiment, the front rod 38 extends into pivot attachments 52 (only one shown) in the roof support structure 40. The roof support structure 40 has two downwardly hanging guide members 70 and 72. Guide member 70 includes a slot 74 and a lower cam surface 76. Similarly, guide member 72 includes a slot 84 and a lower cam surface 86. The roof 60 includes a generally horizontal surface 62 and a downwardly extending peripheral lip 64. Preferably, support rods 44 and 46 extend between the front rod 38 and struts 30 and 32 respectively.

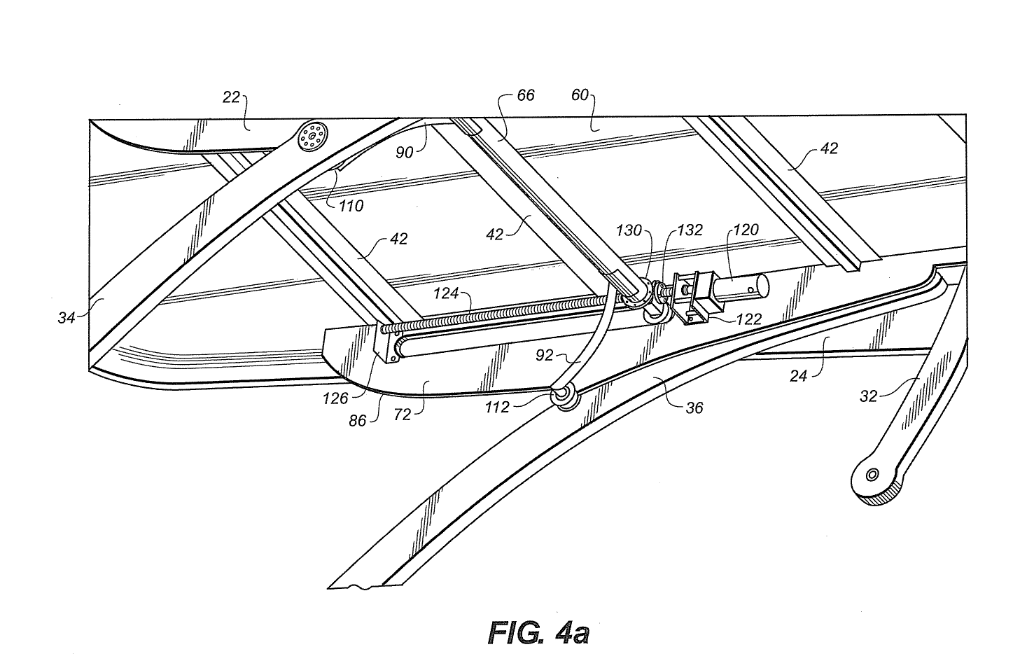

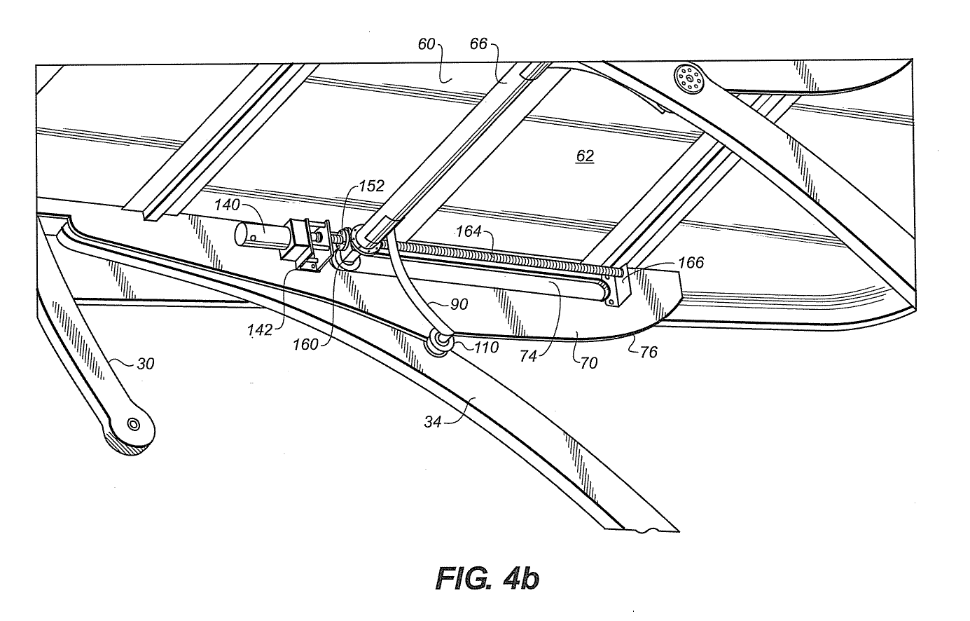

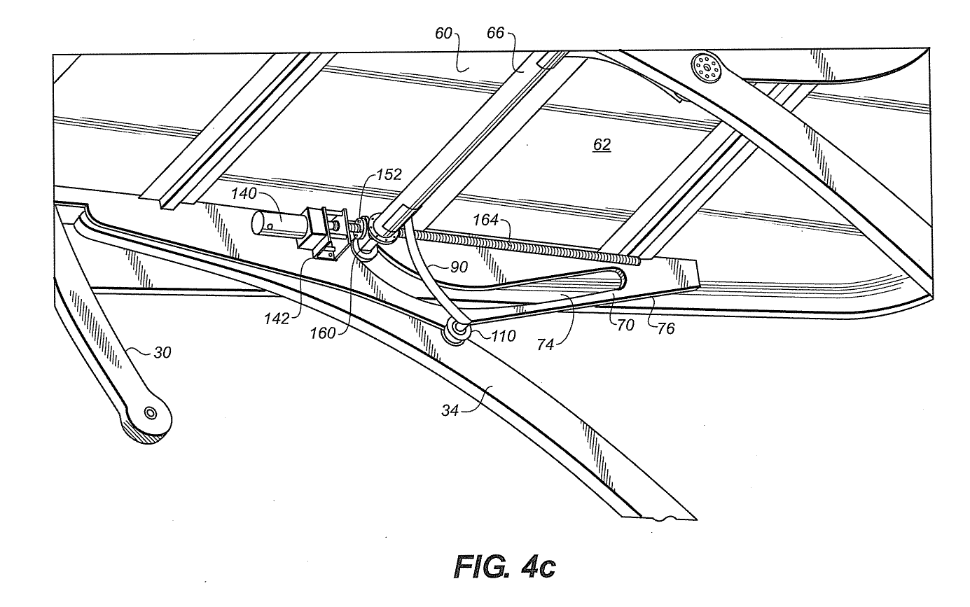

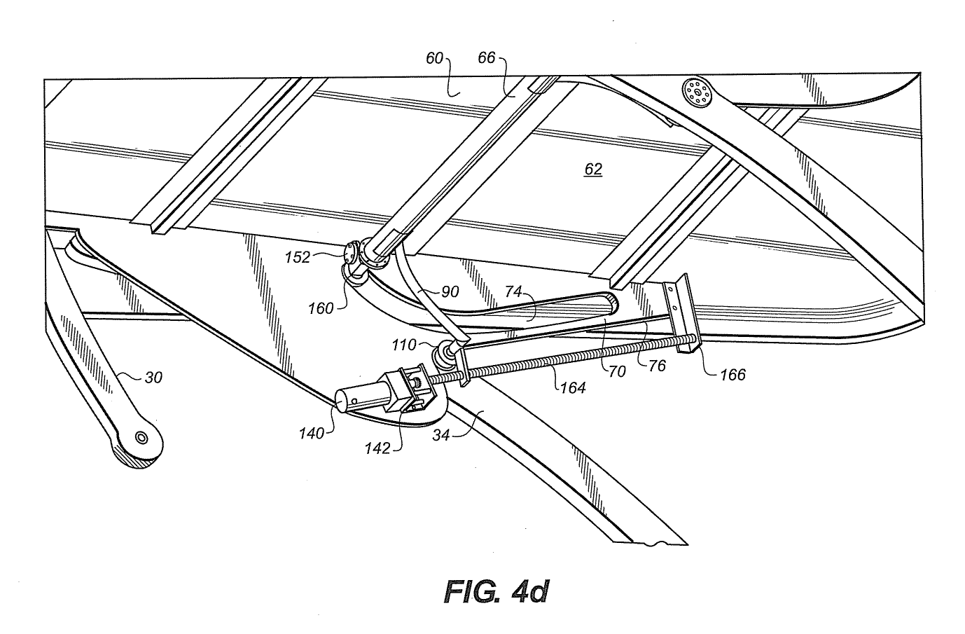

As best seen in FIGS. 4a and 4b, a guide rod 66 extends from the strut 34 on a first side 22 of the roof 60, through slot 74 and through slot 84, and to the strut 36 on the opposite side 24 of the roof 60. Support rods 90 and 92 extend from the guide rod 66 to struts 34 and 36, respectively. Rollers 110 and 112 are attached to struts 34 and 36, respectively.

As best seen in FIG. 4a, in one embodiment, a motor 120 is mounted to guide member 72 by mounting frame 122. A collar 130 surrounds guide rod 66 and includes a threaded ring 132. The motor 120 includes a screw 124 which is threaded inside of the ring 132. The screw 124 is rotationally supported by support 126. When the motor 120 turns the screw 124 the ring 132 moves toward and away from the motor 120 depending on the direction that the screw 124 is turning.

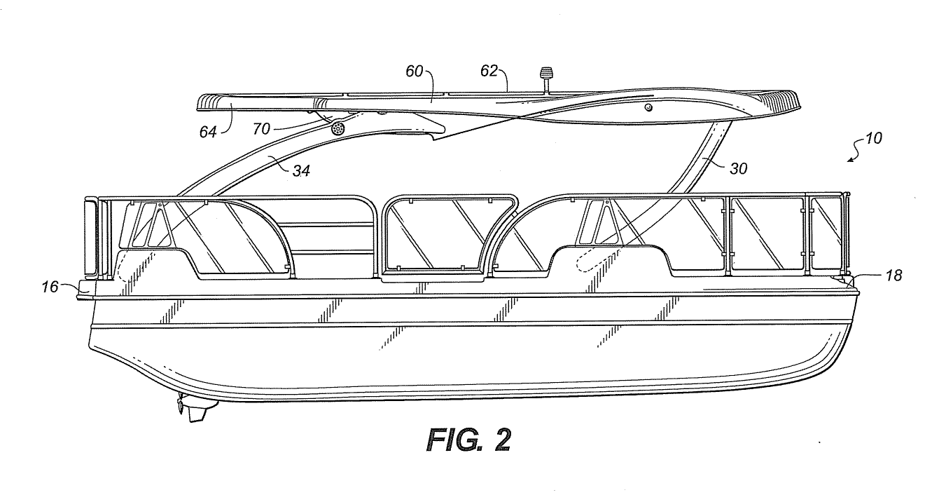

As best seen in FIG. 4b, in one embodiment, a second motor 140 includes a screw 164 supported by support 166. The second motor 140 is mounted to guide member 70 by mounting frame 142. Ring 152 is connected to collar 160 and the guide rod 66 moves with the ring 152. Because the struts 34 and 36 cannot move to the left as viewed in FIG. 1, movement of the guide rod 66 causes the roof 60 with the support structure 40 to move to the right as viewed in FIG. 2.

FIGS. 4c and 4d show another embodiment of the present invention. In this embodiment, the slot 74′ is curved and the surface 76′ is straight, but angled. In FIG. 4c, the motor 140 is attached by mounting frame 142 and has a screw drive 164 which moves collar 152 and causes the guide rod 66 to follow the curved path of the slot 74′. In FIG. 4d, the motor 140 and screw drive 164 act on the roller 110, through link 168, instead of the collar 160. The motor 140 and screw drive 164 can also act on the roller 110 in the embodiment of FIG. 4a in a manner similar to that shown in FIG. 4d.

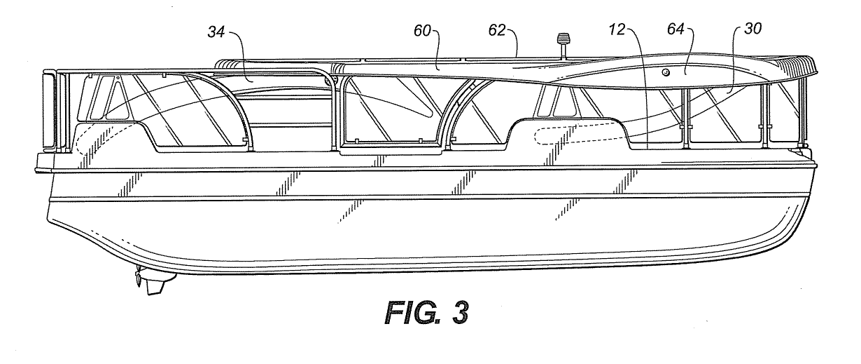

As the roof 60 moves, rollers 110 and 112 slide along cam surfaces 76 and 86, respectively. The curvature of cam surfaces 76 and 86 (FIGS. 4a and 4b) or the curvature of the slot 74′ (FIGS. 4c and 4d) is designed such that in all positions of the roof 60, the roof is maintained in a substantially horizontal position. When the roof 60 moves from the deployed position as shown in FIG. 1, through the partially retracted position as shown in FIG. 2, to the retracted position as shown in FIG. 3, the struts 30, 32, 34 and 36 pivot downwardly and to the right as viewed in FIG. 2. In the retracted position, the roof 60 is closer to the boat deck 12 than when the roof 60 is in the deployed position. In the retracted position, the roof 60 covers a different portion of the boat deck 12 than when the roof is in the deployed position. It will be understood by those of ordinary skill in the art that the roof may be designed to cover different portions of the boat deck 12 than as shown in the figures. For example, in the deployed position, the roof can be covering primarily the aft section 16 of the boat 10 as shown in FIG. 1, or can be covering primarily the fore section 16 (not shown).

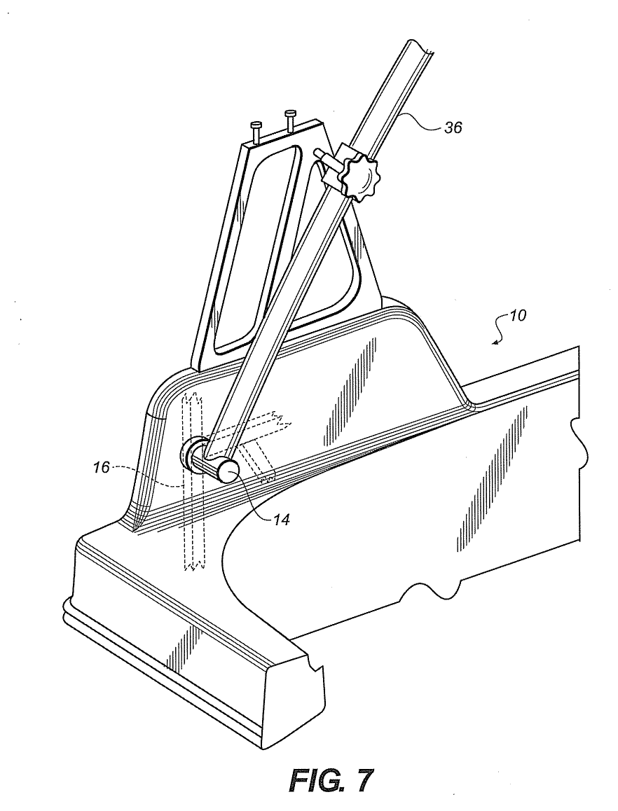

FIG. 8 illustrates another aspect of the present invention. The boat 10 is shown with the roof 60 in a retracted position. The deck 12 has a perimeter 230. Between the roof 60, the deck 12 and the perimeter 230 are a port section 214 and a starboard section 216. The port section 214 and the starboard section 216 are sized such that with the roof 60 in the retracted position, the port hull 220 and the starboard hull 222 can fit on the deck 12, on the port section 214 and the starboard section 216 respectively. The port hull 220 and the starboard hull 222 will fit between the deck 12 and the roof 60. The port hull 220 and the starboard hull 222 are sized such that they can be placed on the deck 12 such that they are substantially within the perimeter 230.

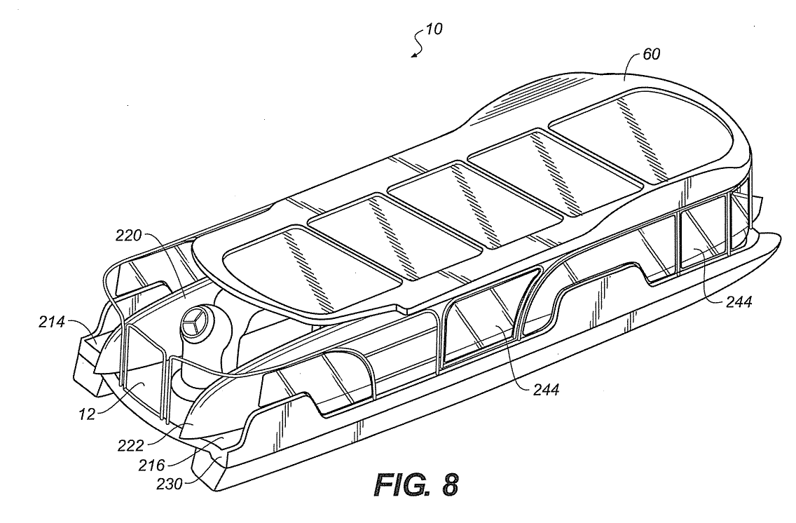

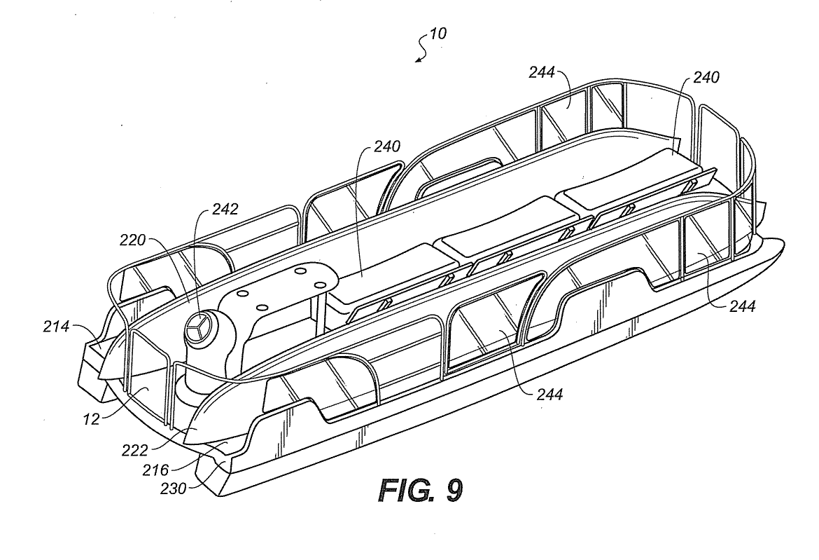

FIG. 9 illustrates the boat 10 with the roof 60 removed for illustration purposes. As shown in FIG. 9, in one embodiment, seats 240 and the navigation controls 242 are placed on the deck 12 such that the hulls 220 and 222 can be placed one on each side of the seats 240 and the navigation controls 242 while still remaining substantially within the perimeter 230. Other configurations of items on the deck 12 are possible. For example, the items, such as the seats 240, may be removably or slidably attached (not shown) to the deck 12. The boat 10 also includes side panels 244 around the boat perimeter 230. The boat hulls 220 and 222 remain within the side panels 244.

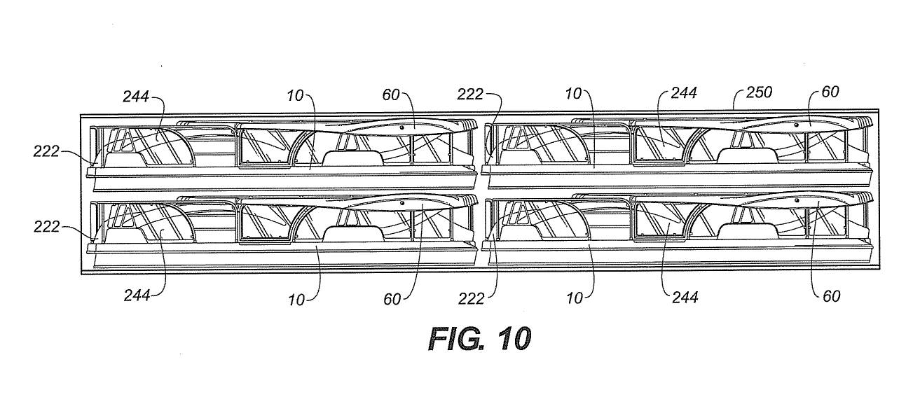

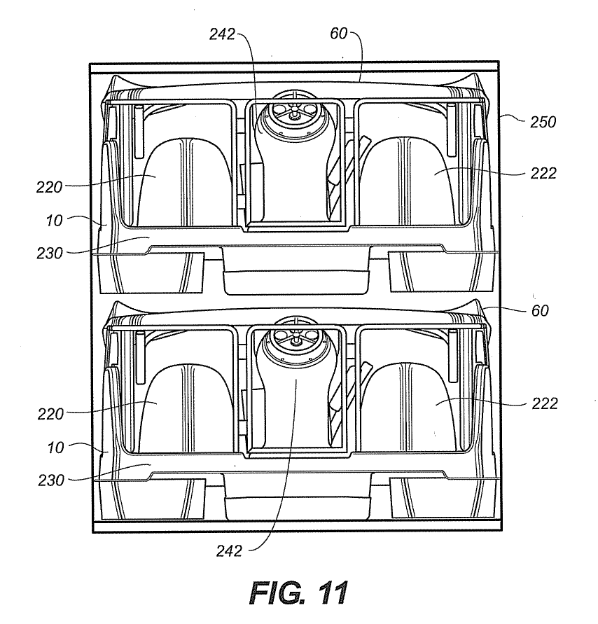

FIGS. 10 and 11 illustrate one advantage of the present invention. FIG. 10 is a side view of a standard shipping container 250 with a side panel removed. The boats 10 may have, for example, dimensions of 22 feet in length, 7 feet, 4 inches in width and 8 feet in height, although other dimensions may be desirable. A standard high cube 45-foot shipping container has internal dimensions of 44 feet, 6.7 inches in length, 7 feet, 8.2 inches in width and 8 feet, 9.7 inches in height. With these dimensions, four boats 10 fit within the shipping container 250 with the roofs 60 in the retracted position, and the hulls 220 and 222 on the deck 12. FIG. 11 illustrates an end view of the shipping container 250 with the end panel removed. Two boats 10 are stacked on top of one another such that the boats 10 can fit within the shipping container 250.

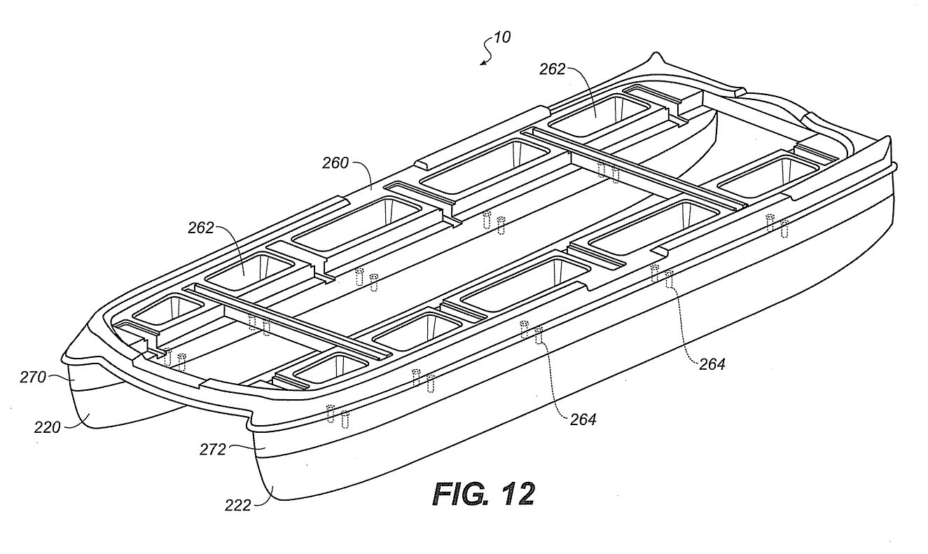

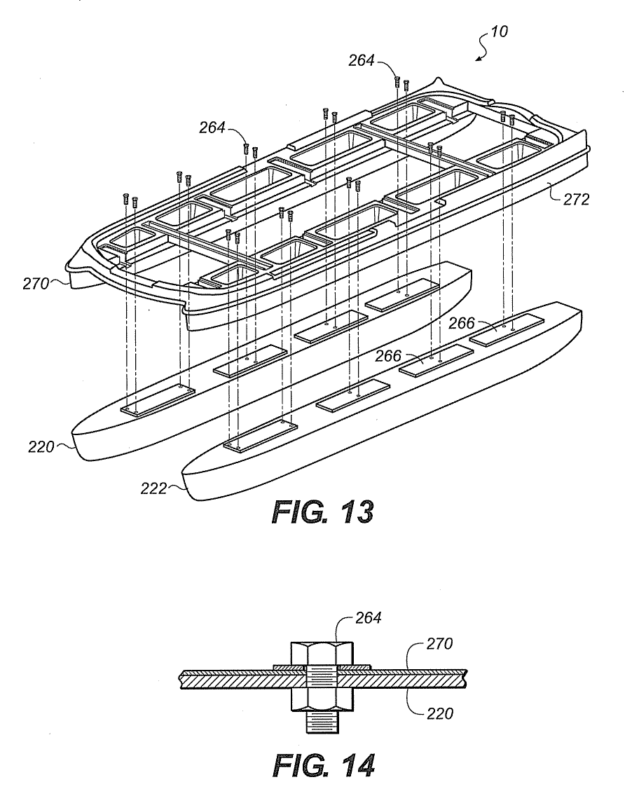

FIGS. 12-14 show a portion of the boat illustrating one method of attaching the hulls 220 and 222 to the boat 10. The boat 10 has a framework 260 with access openings 262 therein. Bolts 264 are accessed through access openings 262 and are threaded through upper hull sections 270 and 272 and into panels 266 on hulls 220 and 222. As illustrated in FIGS. 13 and 14, the bolts 264 secure the hulls 220 and 222 to the framework 260. The hulls 220 and 222 are preferably made of fiber-reinforced plastic, but could be made of thermoformed plastic, aluminum or other suitable material. By removing the bolts, the boat hulls 220 and 222 can be removed and placed on the boat deck 12 as illustrated in FIGS. 8 and 9.

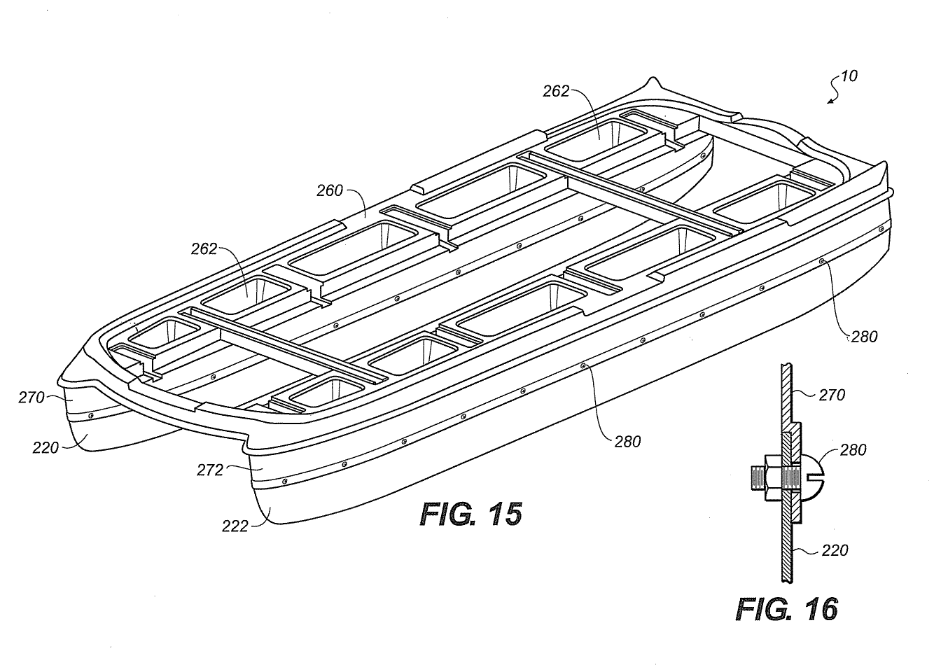

An alternative attachment method is illustrated in FIGS. 15 and 16. In FIGS. 15 and 16, the boat hulls 220 and 222 are attached to upper hull sections 270 and 272 respectively. Bolts 280 are threaded through upper sections 270 and 272 and into the boat hulls 220 and 222 to secure the boat hulls 220 and 222 to the upper sections 270 and 272. It will be understood by those of ordinary skill in the art that other attachment methods such as using screws are possible as an alternative to bolts. By removing the bolts 280, the boat hulls 220 and 222 can be removed and placed on the boat deck 12 as illustrated in FIGS. 1 and 2.

One of ordinary skill in the art will appreciate that there are many equally feasible physical arrangements of the various elements described. The foregoing description is meant to provide a conceptual overview and should not be viewed as limiting the invention. While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method of preparing a boat, having two hulls, a deck and an outside perimeter, for transportation or storage, comprising:
detaching the hulls from the boat; and
placing the hulls on the deck such that the hulls do not extend substantially beyond the outside perimeter of the boat.

2. The method of claim 1 wherein the deck has access panels and wherein the hulls are attached to the boat by bolts and the bolts are inserted through the access panels in the deck of the boat into the hulls.

3. The method of claim 1 wherein the boat further includes upper hull sections and wherein the hulls are attached to the upper hull sections by bolts inserted through the hulls and the upper hull sections.

4. The method of claim 1 wherein the boat further includes a roof and further including the step of moving the roof from a position above the deck to a position substantially closer to the deck.

5. A method of transporting a boat, having two hulls, a roof, a deck and a perimeter, comprising:
detaching the hulls from the boat;
placing the hulls on the deck such that the hulls remain substantially within the perimeter of the boat,
retracting the roof of the boat such that the roof moves from a first position in which the roof is above the boat to a second position in which the roof is substantially closer to the boat;
placing the boat within a shipping container,
moving the shipping container.

6. A method of transporting four boats each having a roof, a hull, a deck and a perimeter:
removing a portion of the boat hull of each boat;
placing the portion of the boat hull of each boat on the deck of the boat such that the portion of the boat hull is substantially within the perimeter;
retracting the roof of each boat such that it is adjacent the portion of the boat hull;
placing the four boats in a single shipping container; and
moving the shipping container.

7. A boat having a deck, the boat comprising:
a hull removably attached to the boat;
the deck including a first area sized to receive the hull;
the deck having a perimeter sized such that when the first area receives the hull, the hull does not extend substantially outside of the perimeter.

8. The boat of claim 7 further including a second hull removably attached to the boat and the deck including a second area sized to receive the second hull such that the second hull does not extend substantially outside of the perimeter.

9. The boat of claim 8 further including:
first and second struts, pivotally attached to the boat;
third and fourth struts pivotally attached to the boat;
a roof operatively attached to the third and fourth struts;
a motor operatively connected to the retractable roof assembly for moving the roof such that the roof moves from a first position in which the roof is above the boat to a second position in which the roof is substantially closer to the boat.

10. The boat of claim 9 further including an upper hull section and wherein the deck has openings therein and the hull is attached to the upper hull section with bolts inserted through the openings in the deck, through the upper hull section and into the hull.

11. The boat of claim 9 wherein the boat has an upper hull section and wherein the hull is attached to the boat by bolts extending through the hull and the upper hull section.
